(19) United States
(12) Patent Application Publication
(10) Pub. No.: US 2014/0297444 A1
(43) Pub. Date: Oct. 2, 2014

(54) LOT BIDDING OPTIMIZATION AND COMMUNICATION

(71) Applicant: AUCTION.COM, LLC, Irvine, CA (US)

(72) Inventors: Elizabeth O'Brien, Irvine, CA (US); Samuel Harrity, Irvine, CA (US)

(73) Assignee: AUCTION.COM, LLC, Irvine, CA (US)

(21) Appl. No.: 14/213,513

(22) Filed: Mar. 14, 2014

Related U.S. Application Data
(60) Provisional application No. 61/802,976, filed on Mar. 18, 2013.
(60) Provisional application No. 61/801,976, filed on Mar. 15, 2013.

(51) Int. Cl. G06Q 30/08

(52) U.S. Cl. CPC G06Q 30/08
USPC 705/26.3

(57) ABSTRACT

A method and system of optimizing portion bidding in a lot auction is provided. Disclosed examples include a bid detector configured to identify the occurrence of portion bidding in a lot auction. Further features can include communication module configured to communicate auction updates to the lot bidders participating in the auction.

### RELATED APPLICATION

This application claims the benefit of priority to Provisional Application No. 61/801,976 filed on Mar. 15, 2013, entitled LOT BIDDING OPTIMIZATION AND COMMUNICATION; the aforementioned priority application being hereby incorporated by references in its entirety.

### TECHNICAL FIELD

Examples described herein relate to online markets, and more specifically, to a system and method for optimizing lot bidding. The system and method may further include communicating updates to lot bidders.

### BACKGROUND

Numerous online auction forums exist that enable consumers and sellers to transact for various kinds of items, such as collectibles, electronics and other goods or services. Some auctions listed on the auction forum may be termed as lot auctions, wherein a single auction takes place for multiple items.

### BRIEF DESCRIPTION OF THE DRAWINGS

The disclosure herein is illustrated by way of example, and not by way of limitation, in the figures of the accompanying drawings and in which like reference numerals refer to similar elements, and in which:

FIG. 1 illustrates an example system for optimizing lot bidding and communicating updates;

FIG. 2 illustrates a similar example system for optimizing lot bidding and communicating updates;

FIG. 3 illustrates an example method of optimizing lot bidding and communicating updates;

FIG. 4 is a block diagram that illustrates a computer system upon which examples described herein may be implemented; and

FIG. 5 is an example screen shot of a notification including optimized bidding results and activity being transmitted during a lot auction.

### DETAILED DESCRIPTION

Examples described herein provide for an auction forum including at least one lot auction for multiple items. Variations can include an auction analysis component configured to analyze auction data from respective auctions taking place. The auction analysis component can include a bid detector to determine and/or identify lot auctions in which portion bidding can take place. Further examples include an optimization trigger configured to enable competitive portion bidding when a lot auction is identified. Still further, examples include a communication module configured to submit lot bidding updates to lot bidders participating in the lot auction and/or auction forum users.

A lot auction is an auction in which multiple bids may be placed for multiple items in a single auction. For example, a lot auction for five items can yield a first bid by a first lot bidder for two of the items at a first amount. The same lot auction can yield a second bid by a second lot bidder for four of the items for a second amount. Thus, profuse combinations of lot bids by multiple lot bidders can result in a lot auction. When such portion bidding occurs, competitive portion bidding can be enabled amongst the lot bidders for the one or more items in the lot auction. Competitive portion bidding can be a simple progression of the portion bidding already occurring in the lot auction. Alternatively, competitive portion bidding can be a phase of the lot auction in which lot bidders can place bids for individual or multiple items for the purpose of challenging at least a portion of the portion bids. When such competitive bidding takes place, the auction forum can proceed to optimize such competitive bidding and concurrently communicate the corresponding portion bidding activity to the auction forum interface, where lot bidders can view bidding activity.

Further, the auction forum can send a notification to a current highest bidder participating in the lot auction that his bid has been exceeded. The notification can include a bid required to overcome the exceeding bid. Still further, the notification can be sent to any participant of the lot auction, including any lot bidder who can have had a highest bid during the lot auction.

Among other benefits, examples described herein achieve a technical effect in which programs and operations that require access to resources of a network-based file system are performed significantly faster than more conventional approaches. For example, programs can asynchronously issue file system operation requests from the network-based file systems in order to implement programs such as copying directories. In turn, these programs can complete their objectives at a speed that is based on efficient utilization of the network's maximum transmission unit (MTU) and maximum bandwidth. Accordingly, examples such as described enable certain programs that require use of network-based file systems to complete their objectives in a fraction of the time as compared to more conventional approaches that rely on synchronous, message-based communications as between the client terminal and the network-based file systems.

Accordingly, examples are described in which portion bidding in a lot auction is identified. For example, an evaluation of bids during a lot auction in relation to other bids can indicate the presence portion bidding. An auction analysis component can include a bid detector configured to evaluate and/or analyze lot auctions for such portion bidding, and upon identifying such portion bidding, the bid detector can execute an optimization trigger which can enable an optimization component. Competitive portion bidding can take place where lot bidders compete for the one or more items listed in the lot auction, and various combinations of lot bidders, items, and bid values may result. The optimization component can be configured to optimize the competitive bidding so as to maximize the return on the lot auction on behalf of the seller and/or the auction forum. Furthermore, a communication module can be included to submit or otherwise stream updates to the lot bidders and/or auction forum users. Upon concluding the lot auction period, the items can be distributed to highest lot bidders according to a final optimization result. This result can include any combination of lot auction items and lot bidders.

Systems and methods for optimizing lot bidding for a lot auction taking place on an auction forum are disclosed. The method includes monitoring the lot auction on the auction forum, and identifying portion bidding by one or more bidders taking place in the lot auction. In response to such portion bidding the system can be configured to optimize the portion bidding by determining a maximum return on the lot auction at any given time during the lot auction. Furthermore, in response to optimizing the portion bidding, the system can send a notification to participants of the lot auction indicating a bid amount that is required to overcome a highest portion bid. The notification can be sent to any one or more of the lot auction participants, such as current highest portion bidder. The notification can include optimized bidding results and activity. Furthermore, the system can be further configured to dynamically track portion bids received during the lot auction, and continually optimize the portion bidding, including determining whether any combination of portion bids (or potential portion bids) is more optimal than a current highest bid for the lot auction.

One or more variations described herein can be implemented using programmatic modules or components. A programmatic module or component includes a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more variations described herein can be implemented through the use of instructions that are executable by one or more processors. These instructions can be carried on a computer-readable medium. Machines shown or described with figures below provide examples of processing resources and computer-readable mediums on which instructions for implementing examples of the invention can be carried and/or executed. In particular, the numerous machines shown with examples of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, examples can be implemented in the form of computer-programs, or a computer usable carrier medium capable of carrying such a program.

System Architecture

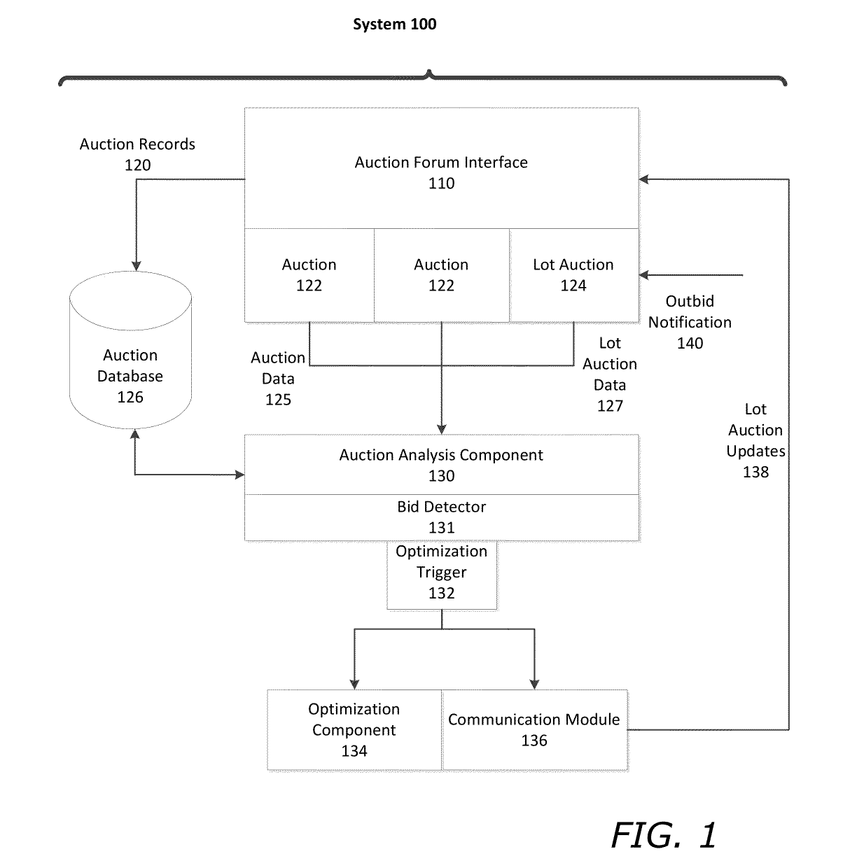

FIG. 1 illustrates a system for optimizing lot bidding. The system includes functions relating to communicating updates to an auction forum interface. A system 100 such as shown by an example of FIG. 1, can be implemented in connection with an online auction service for any type of commercial item, such as, for example, real property items, (e.g., homes, real-estate notes, commercial property), motor vehicles (e.g., automobiles, motorcycles, boats), consumer electronics, collectibles, or clothing.

In an example of FIG. 1, system 100 includes functionality that can be implemented by processes, logical components and/or modules. Furthermore, examples described with respect to FIG. 1 achieve a technical effect in which programs and operations that require access to resources included in FIG. 1 are performed significantly faster than more conventional approaches. Such components as shown can be programmatically employed to complete their objectives at a speed that is based on efficient utilization of the network's maximum transmission unit (MTU) and maximum bandwidth. Accordingly, examples such as described enable certain programs that require use of network-based file systems to complete their objectives in a fraction of the time as compared to more conventional approaches that rely on synchronous, message-based communications as between the client terminal and the network-based file systems.

In an example of FIG. 1, system 100 includes an auction forum interface 110, where users participate in various auctions 122 that comprise one or more lot auctions 124. During a lot auction period, lot bidders can place bids for once or more items listed in the lot auction 124. An optimization component 134 can be included to process lot auction bidding activity and further optimize the lot bidding in order to, for example, maximize the return of the lot auction 124 on behalf of the seller and/or auction forum.

A communication module 136 can be included to communicate lot auction updates 138 to the auction forum interface 110 where lot bidders can view, for example, the bidding activity of the lot auction 124. The lot auction updates 138 can simply illustrate lot bids placed by lot bidders during the auction. Alternatively, the lot auction updates 138 can present results and activity of optimized bidding during the lot auction 124. The communication module 136 can be coupled to the optimization component 134 such that the optimized bidding results and activity may be relayed to the auction forum interface 110.

In many variations, the system 100 includes an auction analysis component 130 configured to analyze and/or process auction data 125 from the auctions 122 taking place within the auction forum. The auction analysis component 130 can further be configured to acquire auction records 120 from an auction database 126 coupled to the auction forum. At any given time, one or more lot auctions 124 may be taking place on the auction forum, in which lot auction data 127 may too be processed by the auction analysis component 130. In one implementation, the auction analysis component 130 includes a bid detector 131 configured to identify portion bidding activity occurring within the lot auction 124. When portion bidding activity is identified, an optimization trigger 132 coupled to the bid detector 131 may enable the optimization component 134. The optimization component 134 can be configured to optimize portion bidding during the lot auction 124 as described above.

Examples may be configured such that the communication module 136 is coupled to the optimization component 134. The communication module 136 may be configured to submit or otherwise stream the lot auction updates 138 to the auction forum interface 110. The lot auction updates 138 can include a simple illustration of bidding activity, an optimization bidding report, live content regarding optimized bidding activity, results and information regarding the lot auction 124, etc.

The system 100, as shown by an example of FIG. 1, can include the auction forum interface 110 associated with the auction forum. The auction forum may be an online auction service wherein one or more auctions 122 may be listed and auction forum users participate by viewing auction activity, placing bids, viewing items up for auction, etc. The auction forum interface 110 may be in the formed of, for example, an auction webpage listing one or more auctions 122. The auction forum interface 110 can be coupled to the auction database 126, where auction records 120 can be directed and stored. The auction records 120 can include, for example, past transaction data including items sold, item types, buyer profile data, seller profile data, individual auction data, compiled auction data, localities, etc.

Various items can be listed for auction on the auction forum interface 110. Such items include, for example, real property items, (e.g., homes, real-estate notes, commercial property), motor vehicles (e.g., automobiles, motorcycles, boats), consumer electronics, collectibles, or clothing. During an auction 122, auction data 125 such as, for example, buyer data, reserve price, current bid values, items up for auction, item types, location of the seller, etc., may be compiled or directed to the auction database 126. Automatic bidding may proceed on behalf of the seller and/or auction forum so long as such bids do not exceed a reserve price for individual auctions 122. Finally, auctions 122 can be extended upon the occurrence of one or more given events, such as, for example, a bid being placed that fails to amount to the reserve price.

At any given time, the auction forum can include a lot auction 124. The lot auction 124 lists multiple items up for auction in a single auction, where lot bidders may place bids for one or more items. The lot auction 124 lists a plurality of the same item or a variety of two or more items. These items can include, for example, real property items, (e.g., homes, real-estate notes, commercial property), motor vehicles (e.g., automobiles, motorcycles, boats), consumer electronics, collectibles, or clothing. Furthermore, the lot auction data 127 such as, for example, buyer data, reserve price, current bid values, items up for auction, item types, location of the seller, etc., can also be compiled or directed to the auction database 126. Also, automatic lot bidding may proceed on behalf of the seller and/or auction forum so long as such lot bids do not exceed a set reserve price for individual lot auctions 124. Finally, lot auctions 124 can be extended upon the occurrence of one or more given events, such as, for example, a lot bid being placed that fails to amount to the reserve price.

The auction data 125 and/or lot auction data 127 can further be directed to the auction analysis component 130. The auction analysis component 130 can be configured to perform one or more functions relating to the one or more auctions 122 or lot auctions 124. For example, the auction analysis component 130 can be configured to extend an auction period for one or more listed auctions 122 or lot auctions 124 upon the occurrence of an event. Additionally or as an alternative, the auction analysis component 130 may be configured to evaluate auction data 125 in light of auction records 120 in order to determine, for example, whether or not bids for a respective auction 122 are likely to meet the reserve price. In many variations, the auction analysis component 130 can include one or more elements or modules performing given functions relating to the auction forum.

The auction analysis component 130 can include the bid detector 131 configured to identify portion bidding activity taking place in lot auctions 124. The bid detector 131 can be configured to analyze lot auction data 127 in order to identify or otherwise determine whether such portion bidding activity may be taking place during the lot auction 124. Portion bidding activity may be identified, for example, when the bid detector 131 determines that a bid has been placed by a lot bidder for multiple items listed in the lot auction 124. Furthermore, portion bidding may be identified when the bid detector 131 determines that multiple bids have been placed by lot bidders for multiple items during the lot auction 124. In other variants, portion bidding may be identified when the bid detector 131 determines that a lot bid has been placed for less than the total number of items listed in the lot auction 124.

Once portion bidding has been identified by the bid detector 131, the optimization trigger 132 is executed. The optimization trigger 132 can be coupled to the bid detector 131 and can be configured to automatically execute upon the identification of portion bidding activity. Alternatively, the bid detector 131 can be configured to make a determination of whether or not to execute the optimization trigger 132. For example, the bid detector 131 can execute the optimization trigger 132 only upon identifying widespread portion bidding activity. Alternatively, the bid detector 131 can execute the optimization trigger 132 upon identifying a specific type of portion bidding (e.g., portion bids placed by lot bidders as opposed to automatic lot bids).

Once the optimization trigger 132 is executed, competitive portion bidding can be enabled for the lot auction 124. Competitive portion bidding can be a simple progression of the portion bidding detected by the bid detector 131. In this scenario, portion bidding can continue during the lot auction 124, but can simply be relabeled or identified as competitive bidding after the optimization trigger 132 has been executed. In other variations, competitive portion bidding can have already transpired prior to the optimization trigger 132 being executed. Alternatively, competitive bidding can be a phase of the lot auction 124 in which lot bidders can place bids for individual or multiple items for the purpose of challenging at least a fraction of the portion bids. For example, multiple portion bids can be placed by lot bidders participating in the lot auction 124. Once the optimization trigger 132 is executed the competitive bidding phase can be enabled in which lot bidders can compete for each item, or multiple items, listed in the lot auction 124. In such a phase, competitive bids can be placed that partially undercut of a portion bid. In other words, for example, a competitive bid can be placed for one or more items already specified in a portion bid for multiple items listed in the lot auction 124.

The system 100 can include the optimization component 134 that can be configured to optimize lot bidding. The optimization component 134 can be enabled, for example, when the optimization trigger 132 is executed. However, in other examples, the optimization component 134 can be enabled when for example, the lot auction 124 begins or when the bid detector 131 detects portion bidding activity. The optimization component 134 can be coupled to the optimization trigger 132, and can be enabled by the execution of the optimization trigger 132. Furthermore, the optimization component 134 can be coupled to the bid detector 131, and can be enabled by an operation performed by the bidding detector 131. Still further, the optimization component 134 can be coupled to the auction forum, and can be enabled, for example, once a lot auction 124 begins. In similar examples, the optimization component 134 can be placed in a standby mode once a lot auction 124 begins, and subsequently be enabled once portion bidding occurs. Similarly, the optimization component 134 can be configured to detect portion bidding activity during the lot auction 124. Further, the optimization component 134 can be enabled once the lot auction period ends.

The optimization component 134 can be configured, as stated above, to optimize lot bidding. For example, the optimization component 134 can be configured to maximize the return on the lot auction 124 on behalf of the seller and/or the auction forum. Additionally or as an alternative, the optimization component 134 can perform one or more operations in which lot bidding, or portion bidding, data is inputted and analyzed by the optimization component 134, and a resulting maximum value for the lot auction 124 is outputted. The optimization component 134 can perform such operations continuously so as to produce constant updates for the maximum lot auction value. Further, the optimization component 134 can be directly coupled to the auction forum interface 110, and thus provide auction forum users, and/or lot bidders participating in the lot auction 124, with continuous information regarding lot auction progress (e.g., lot bidder IDs currently listed as a highest bidders for one or more lot auction items, current highest bids for the one or more listed items, aggregate bids for multiple items by a specified current highest lot bidder, etc.). Upon completion of the lot auction 124, the optimization component 134 can provide final lot auction results and activity to the auction forum interface 110, where lot auction participants and auction forum users can view such information.

The system can further include the communication module 136 configured to submit or otherwise communicate lot auction updates 138 to the auction forum interface 110. The communication module 136 can be coupled to the optimization component 134, and can be enabled simultaneously with the optimization component 134. The communication module 136 can be enabled upon the execution of the optimization trigger 132. In variations, the communication module 136 can be enabled once the bid detector 131 identifies portion bidding activity. In other variations, the communication module 136 can be enabled at the outset of a lot auction 124.

The communication module 136 can be coupled, as stated above, to the optimization component 134, and can be configured to communicate the lot auction updates 138 to the auction forum interface 110. The lot auction updates 138 can be any information, compiled or organized, relating to the lot auction 124, such as portion bidding activity, optimized bidding results and activity, lot bidder IDs, current highest bidders for one or more lot auction items, current highest bids for the one or more listed items, aggregate bids for multiple items by a current highest lot bidder, etc. Lot bidders can then view the lot auction updates 138 on the auction forum interface 110. The communication module 136 can be configured to provide lot auction updates 138 continuously to the auction forum interface 110 so that lot bidders, or lot auction participants, can view lot auction activity in real time. Alternatively, the communication module 136 can be configured to provide intermittent lot auction updates 138 to the auction forum interface 110.

Further, the communication module 136 can be configured to send an outbid notification 140 to a current highest bidder participating in the lot auction that the current highest bid has been exceeded. The outbid notification 140 can include a bid required to overcome the exceeding bid. Still further, the outbid notification 140 can be sent to any participant of the lot auction, including any lot bidder who can have had a highest bid during the lot auction.

In an example of FIG. 1, the auction forum includes one or more lot auctions 124 in which lot bidders can place one more bids on one or more items listed in a single auction. Lot auction data 127 can be directed to a bid detector 131 configured to identify portion bidding activity. If portion bidding is identified, then the optimization trigger 132 can enable the optimization component 134, which can be configured to maximize return on the auction. In further examples, the communication module can be included to communicate lot auction updates 138 back to the auction forum, where lot bidders can view updates relating to the lot auction 124.

In other examples of FIG. 1, the auction forum can include the auction forum interface 110 where auction forum users can participate in one or more auctions 122. At any given time, the auction forum can include one or more lot auctions 124 in which multiple items can be listed in a single lot auction 124. Participants of the lot auction 124 (i.e., lot bidders), can place bids on one or more (or all) of the items. Lot auction data 127 from the lot auction 124 can be transmitted or otherwise communicated to the auction analysis component 130. The auction analysis component 130 can include the bid detector 131, which can be configured to identify portion bidding activity taking place within the lot auction 124. Once portion bidding activity is detected, the bid detector 131 can execute the optimization trigger 132 which can enable the optimization component 134. The optimization trigger 132 can also enable the system 100 to permit competitive portion bidding within the lot auction 124. The optimization component 134 can be configured to maximized return on the lot auction 124. In this manner, the optimization component 134 can perform operations wherein competitive portion bidding data is inputted and analyzed by the optimization component 134, and a resulting maximum value for the lot auction 124 is outputted. Furthermore, the communication module can be included to communicate lot auction updates 138 back to the auction forum, where lot bidders can view updates 138 relating to the lot auction 124. The lot auction updates 138 can be any information, compiled or organized, relating to the lot auction 124, such as competitive bidding activity, optimized bidding results and activity, lot bidder IDs, current highest bidders for one or more lot auction items, current highest bids for the one or more listed items, aggregate bids for multiple items by a current highest lot bidder, etc.

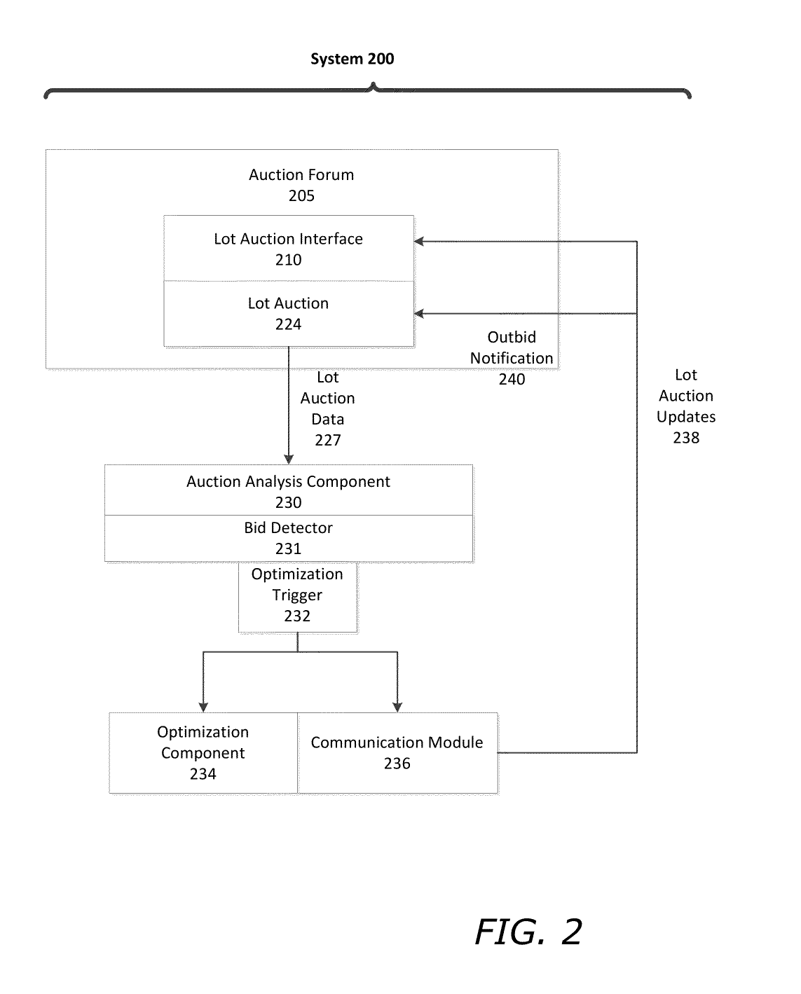

FIG. 2 illustrates a similar example system for optimizing lot bidding. The system can further include functions relating to communicating updates to an auction forum interface. A system 200 such as shown by an example of FIG. 2, can also be implemented in connection with an online auction service for any type of commercial item, such as, for example, real property items, (e.g., homes, real-estate notes, commercial property), motor vehicles (e.g., automobiles, motorcycles, boats), consumer electronics, collectibles, or clothing.

In an example of FIG. 2, system 200 includes functionality that can be implemented by processes, logical components and/or modules. In an example of FIG. 2, system 200 includes a lot auction interface 210, where lot bidders can participate in an associated lot auction 224. The lot auction interface 210 can be further associated with an auction forum 205 as described by examples of FIG. 1. During a lot auction period, lot bidders can place bids for one or more items listed in the lot auction 224. An optimization component 234 can be included to process lot auction bidding activity and further optimize the lot bidding in order to, for example, maximize the return of the lot auction 224 on behalf of the seller and/or auction forum 205.

In an example as shown by FIG. 2, the lot auction interface 210 can include a lot auction 224 in which lot bidders can place one more bids on one or more items listed in a single auction. The lot auction data 227 can be directed to the bid detector 231 configured to identify portion bidding activity. If portion bidding is identified, then the optimization trigger 232 can enable the optimization component 234, which can be configured to maximize return on the auction. In variations, the communication module can be included to communicate lot auction updates 238 back to the lot auction interface 210, where lot bidders can view updates relating to the lot auction 224.

Additionally or as an alternative, the auction forum 205 can include the lot auction interface 210 in which a lot auction 224 are listed. Participants of the lot auction 224 (i.e., lot bidders), can place bids on one or more (or all) of the items. Lot auction data 227 from the lot auction 224 may be transmitted or otherwise communicated to the auction analysis component 230. The auction analysis component 230 can include the bid detector 231 configured to identify portion bidding activity taking place within the lot auction 224. Once portion bidding activity is detected, the bid detector 231 can execute the optimization trigger 232 which can enable the optimization component 234. The optimization trigger 232 can also enable the system 200 to permit competitive portion bidding within the lot auction 224. The optimization component 234 can be configured to maximize return on the lot auction 224. In this manner, the optimization component 234 can perform operations wherein portion bidding data is inputted and analyzed by the optimization component 234, and a resulting maximum value for the lot auction 224 is outputted. Furthermore, the communication module can be included to communicate lot auction updates 238 back to the lot auction interface 210, where lot bidders can view updates 238 relating to the lot auction 224. The lot auction updates 238 can be any information, compiled or organized, relating to the lot auction 224, such as competitive bidding activity, optimized bidding results and activity, lot bidder IDs, current highest bidders for one or more lot auction items, current highest bids for the one or more listed items, aggregate bids for multiple items by a current highest lot bidder, etc.

Further, the communication module 236 can configured to send an outbid notification 240 to a current highest bidder participating in the lot auction that a current highest bid has been exceeded. The outbid notification 240 can include a bid required to overcome the exceeding bid. Still further, the outbid notification 240 can be sent to any participant of the lot auction, including any lot bidder who can have had a highest bid during the lot auction.

Methodology

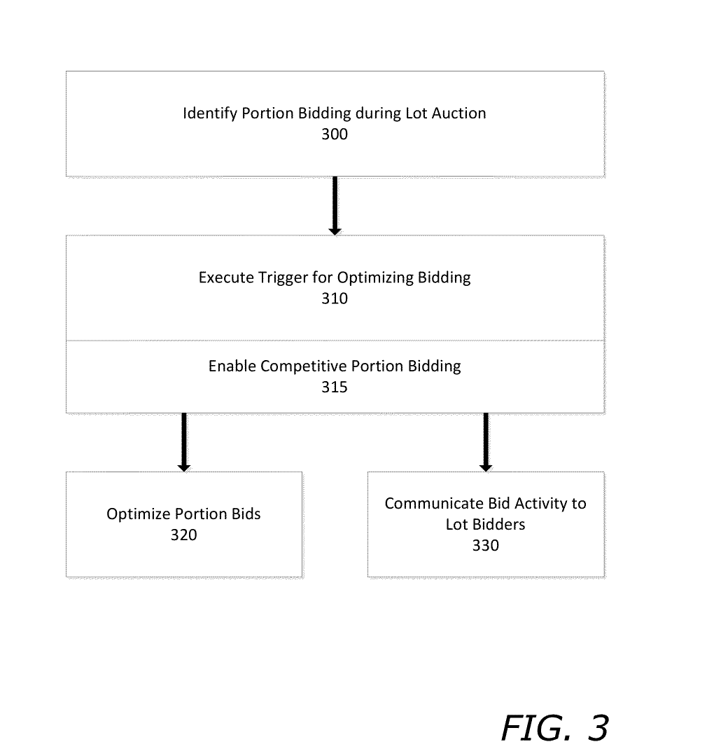

FIG. 3 illustrates an example method of optimizing lot bidding for a lot auction and communicating bidding activity to the lot bids. Methods such as described by examples of FIG. 3 can be implemented using, for example, a system such as described by examples of FIG. 2. Accordingly, reference can be made to elements of system 200.

With reference to FIG. 3, the auction forum 205 can include one or more lot auctions 224 in which multiple items are listed in a single auction. The auction analysis component 230 can be configured to analyze lot auction data 227, and the bid detector 231 can be included to identify portion bidding activity during a lot auction 224 (300).

Upon identifying portion bidding activity, the optimization trigger 232 can be executed to enable an optimization component 234 to optimize lot bidding (310). As an addition or an alternative, the optimization trigger can be further configured to enable competitive portion bidding (315), in which lot bidders participating in the lot auction 224 can place bids on the one or more items that can at least partially undercut a portion bid. The optimization component 234 can be enabled by the optimization trigger 232 to optimize portion bidding (320). In doing so, the optimization component 234 can be configured to maximize return on the lot auction 224 on behalf of the seller and/or auction forum 205.

Further examples can include a communication module 236 configured to communicate bidding activity to the lot bidders using the lot auction interface 210 (330). The communication module 236 can be coupled to the optimization component 234 in order to direct lot auction updates 238 to the lot auction interface 210. In variations, the communication module 236 can be configured or otherwise instructed to process competitive portion bidding activity and submit organized lot auction updates 238 to the lot auction interface 210, where lot bidders and other participants of the lot auction 224 can observe portion bidding activity.

Computer System

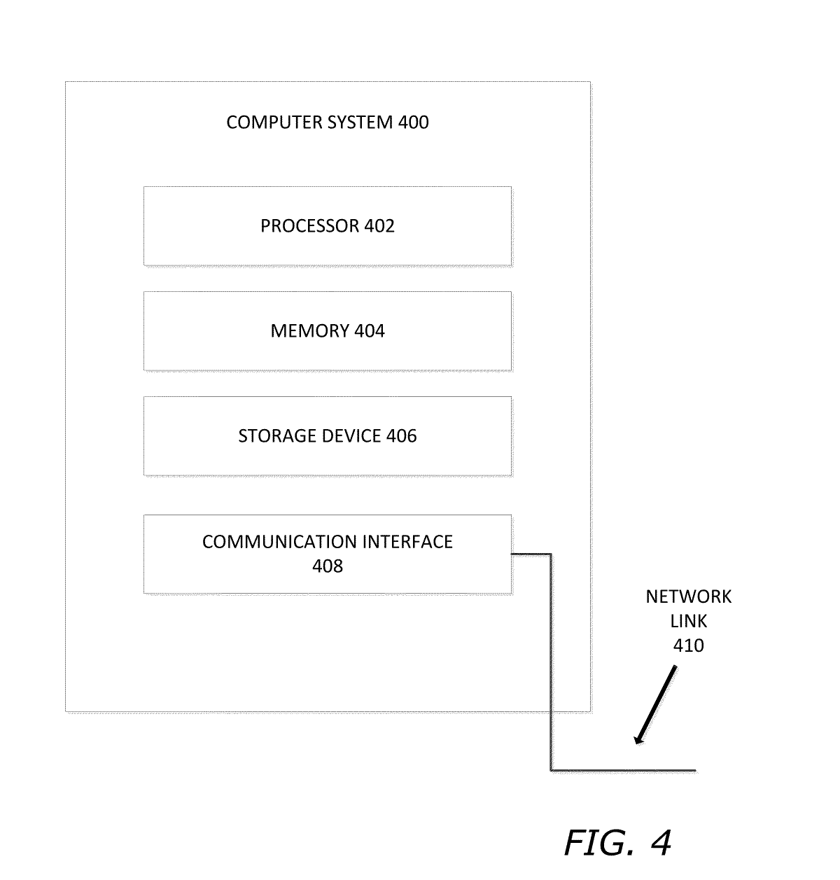

FIG. 4 is a block diagram that illustrates a computer system upon which examples described herein can be implemented. For example, in the context of FIGS. 1 and 2, systems 100 and 200 can be implemented using one or more servers such as described by FIG. 3.

Referring to FIG. 3, computer system 400 includes processor 402, memory 404 (including non-transitory memory), storage device 406, and communication interface 408. Computer system 400 includes at least one processor 402 for processing information. Computer system 400 also includes the main memory 404, such as a random access memory (RAM) or other dynamic storage device, for storing information and instructions to be executed by processor 402. Main memory 404 also can be used for storing temporary variables or other intermediate information during execution of instructions to be executed by processor 402. Computer system 400 may also include a read only memory (ROM) or other static storage device for storing static information and instructions for processor 402. The storage device 406, such as a magnetic disk or optical disk, is provided for storing information and instructions. The communication interface 408 may enable the computer system 400 to communicate with one or more networks through use of the network link 410 (wireless or wireline). The communication interface 408 may communicate with one or more components of the systems 100 and/or 200, including, for example, the auction analysis component, bid detector, auction forum, optimization component, and communication module, through, for example, Ethernet links, the Internet, or via cloud network.

Examples described herein are related to the use of computer system 400 for implementing the techniques described herein. According to one example, those techniques are performed by computer system 400 in response to processor 402 executing one or more sequences of one or more instructions contained in main memory 404. Such instructions may be read into main memory 404 from another machine-readable medium, such as storage device 406. Execution of the sequences of instructions contained in main memory 404 causes processor 402 to perform the process steps described herein. In variations, hard-wired circuitry may be used in place of or in combination with software instructions to implement features described herein. Thus, examples described are not limited to any specific combination of hardware circuitry and software.

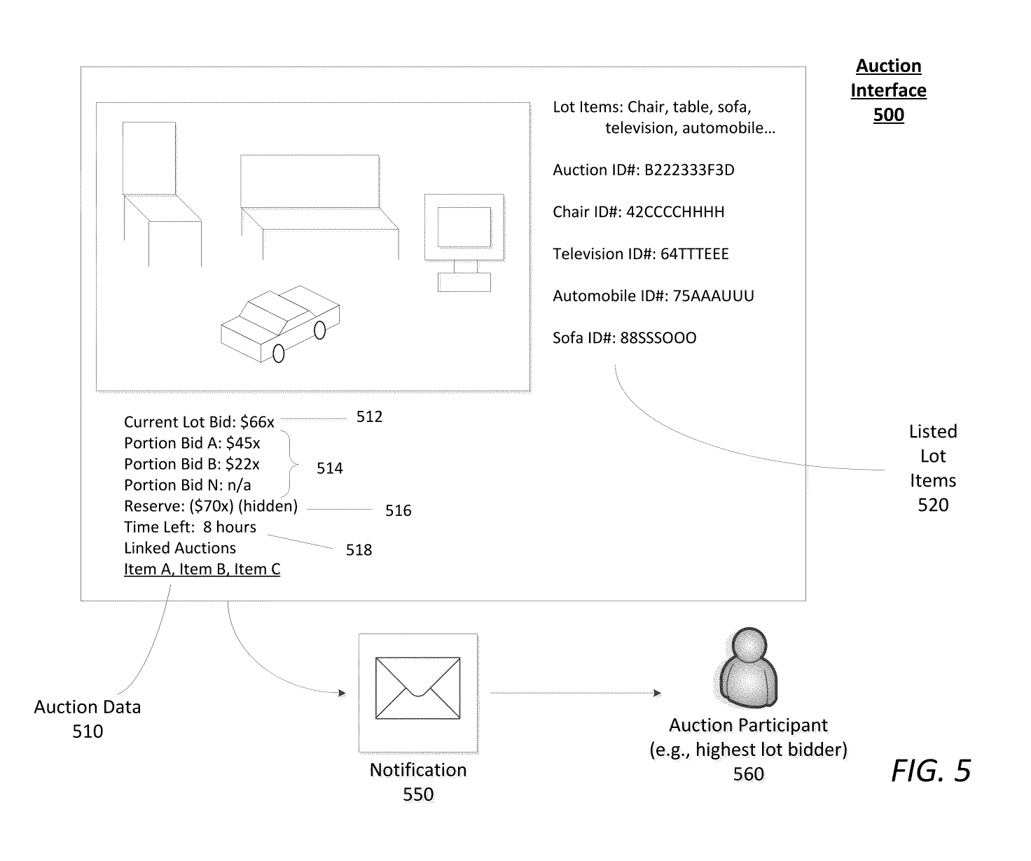

FIG. 5 is an example auction interface 500 illustrating a notification including optimized bidding results and activity being transmitted during a lot auction. The auction interface 500 can be implemented according to examples discussed with respect to FIGS. 1-4. Referring to FIG. 5, the auction interface 500 displays a live lot auction for a number of listed items 520. As an example, the listed lot items 520 include a chair, a table, a sofa, a television, and an automobile. However, any number of items can be listed in a lot auction of the same or varying types. For example, the lot bid may be a liquidation of a quantity of hats or shoes of the same or similar type. In the example shown, the auction interface 500 displays auction data 510 corresponding to a current lot bid 512 (e.g., $66x) for all of the items, a hidden reserve price 516 (e.g., $70x), and a timing feature 518 indicating the remaining time left in the auction period (e.g., 8 hours).

Furthermore, auction participants are enabled to submit any number of portion bids for one or more items in the lot. As such, the displayed auction data can include any number of current portion bids 514 during the lot auction. For example, Portion Bid A has a set value of $45x, which can correspond to, say, the combined television and automobile. Portion Bid B has a set value of $22x, which can correspond to, say, the combined television, chair, and sofa. Accordingly to such portion bids, the example systems discussed above, can proceed to optimize the portion bidding in order to achieve a maximum return on behalf of the seller. Such an optimization procedure can be performed programmatically according to one or more algorithms. As such, optimizing the portion bidding can include determining, based on tracking the portion bids, whether any combination of portion bids is more optimal than a highest bid for the lot auction in order to achieve a maximum return. Furthermore, the system can further take into account potential combinations and potential portion bids in order to suggest, in a notification 550, information corresponding to a combination and/or a portion bid for the combination.

Accordingly, subsequent to analysis (e.g., algorithmic determination of optimal combinations of items and suggested portion bids), a notification 550 can be generated and transmitted to one or more auction participants 560, which may include the seller. The auction participant 560 can be a current highest lot bidder or portion bidder. The notification 550 can include any information pertinent to the lot auction, including optimized bidding results, auction activity, the reserve price for the lot, etc. In certain variations, the seller may include a reserve price for each item in the lot, and the notification may include detailed information regarding the same. The notification 550 may be transmitted to the auction participant 560 via the auction forum, or by any electronic communication means (e.g., SMS, email, etc.).

Although illustrative examples have been described in detail herein with reference to the accompanying drawings, variations to specific examples and details are encompassed by this disclosure. It is intended that the scope of features described herein be defined by claims and their equivalents. Furthermore, it is contemplated that a particular feature described, either individually or as part of a variation, can be combined with other individually described features, or parts of other examples. Thus, absence of describing combinations should not preclude the inventor(s) from claiming rights to such combinations.

What is claimed is:

1. A computer-implemented method for optimizing lot bidding for a lot auction taking place on an auction forum, the method performed by one or more processors and comprising:
monitoring the lot auction on the auction forum, the lot auction including multiple items;
identifying portion bidding by one or more bidders taking place in the lot auction, the portion bidding including one or more bids for a portion of the multiple items; and
optimizing the portion bidding by determining a maximum return on the lot auction at any given time during the lot auction.

2. The computer-implemented method of claim 1, further comprising, in response to optimizing the portion bidding, sending a notification to participants of the lot auction indicating a bid amount that is required to overcome a highest portion bid.

3. The computer-implemented method of claim 2, wherein the notification is sent to a current highest portion bidder.

4. The computer-implemented method of claim 2, wherein the notification includes optimized bidding results and activity.

5. The computer-implemented method of claim 1, further comprising tracking portion bids received during the lot auction, wherein optimizing the portion bidding includes determining, based on tracking the portion bids, whether any portion bid is more optimal than a highest bid for the lot auction.

6. The computer-implemented method of claim 1, wherein the maximum return comprises one or more highest portion bids.

7. The computer-implemented method of claim 1, further comprising automatically submitting one or more bids during the lot auction at or below a reserve price set by a seller of the lot auction.

8. The computer-implemented method of claim 7, further comprising extending an auction period for the lot auction is automatically extended upon the occurrence of one or more events.

9. The computer-implemented method of claim 8, wherein the one or more events include a portion bid being placed by the one or more bidders, the portion bid amounting to less than the reserve price.

10. A system comprising:
one or more processors; and
a memory resource storing instructions for optimizing lot bidding on an auction forum, the instructions, when executed by the one or more processors, causing the one or more processors to:
monitor a lot auction on the auction forum, the lot auction including multiple items;
identify portion bidding by one or more bidders taking place in the lot auction, the portion bidding including one or more bids for a portion of the multiple items; and
optimize the portion bidding by determining a maximum return on the lot auction at any given time during the lot auction.

11. The system of claim 10, wherein the instructions, when executed, further cause the one or more processors to, in response to optimizing the portion bidding, send a notification to participants of the lot auction indicating a bid amount that is required to overcome a highest portion bid.

12. The system of claim 10, wherein the instructions, when executed, further cause the one or more processors to track portion bids received during the lot auction, wherein optimizing the portion bidding includes determining, based on tracking the portion bids, whether any portion bid is more optimal than a highest bid for the lot auction.

13. A non-transitory computer readable medium storing instructions for optimizing lot bidding on an auction forum, the instructions, when executed by one or more processors, causing the one or more processors to:
monitor a lot auction on the auction forum, the lot auction including multiple items;
identify portion bidding by one or more bidders taking place in the lot auction, the portion bidding including one or more bids for a portion of the multiple items; and
optimize the portion bidding by determining a maximum return on the lot auction at any given time during the lot auction.

14. The non-transitory computer readable medium of claim 13, wherein the instructions, when executed, further cause the one or more processors to, in response to optimizing the portion bidding, send a notification to participants of the lot auction indicating a bid amount that is required to overcome a highest portion bid.

15. The non-transitory computer readable medium of claim 13, wherein the instructions, when executed, further cause the one or more processors to track portion bids received during the lot auction, wherein optimizing the portion bidding includes determining, based on tracking the portion bids, whether any portion bid is more optimal than a highest bid for the lot auction.
